(19) United States
(12) Patent Application Publication
(10) Pub. No.: US 2007/0138886 A1
(43) Pub. Date: Jun. 21, 2007

(54) Converting Rotational Motion into Radial Motion

(75) Inventors: Hermano Igo Krebs, Cambridge, MA (US); Lorenzo Masia, Rome (IT)

Correspondence Address: FOLEY HOAG, LLP;PATENT GROUP, WORLD TRADE CENTER WEST, 155 SEAPORT BLVD, BOSTON, MA, 02110, US

(73) Assignee: Massachusetts Institute of Technology, Cambridge, MA (US)

(21) Appl. No.: 11/539,091

(22) Filed: Oct. 5, 2006

Related U.S. Application Data
(60) Provisional application No. 60/729,906, filed on Oct. 25, 2005.

(51) Int. Cl. F16H 37/16

(52) U.S. Cl. 310/112; 74/22 R

(57) ABSTRACT

An apparatus for converting rotational motion into radial motion may include a motor, and arm assembly, and, optionally, a panel. The motor may include two coaxial rotors and a motion generator coupled to the rotors. The arm assembly may include first and second arm attached at their proximal ends to the first and second rotors, respectively. The optional panel may be attached to the distal ends of the arms. The distal ends of the arms may be spatially fixed with respect to one another but rotatable with respect to one another, so that counter-rotation of the rotors can cause both distal ends and the panel, if present, to move radially away from the rotors' axis.

### CROSS-REFERENCE TO RELATED APPLICATION

This application claims the benefit of U.S. Provisional Application No. 60/729,906, filed Oct. 25, 2005, which is hereby incorporated herein by this reference.

### SUMMARY

The present disclosure provides systems and methods for converting rotational motion into radial motion. A free base motor, i.e., a motor having two rotors that are free to rotate instead of a fixed stator and a single rotatable rotor (dual-rotor statorless motor), can convert the relative rotation of the rotors into radial motion of arms that are attached to the rotors under certain constraints. Such a free base motor has applications in a wide variety of fields.

### BRIEF DESCRIPTION OF THE DRAWINGS

The subject matter described below refers to the accompanying drawings, of which:

FIG. 1 schematically depicts the kinematic structure for one embodiment of a free base motor device.

FIG. 2 is a top perspective view of an embodiment of a free base motor device with two panels in a closed position.

FIG. 2A is a top perspective view of the embodiment of a free base motor device of FIG. 2 with two panels in an open position.

FIG. 3 is a perspective view of an embodiment of a free base motor device with six panels in an open position.

FIG. 3A schematically depicts the kinematic structure of the embodiment shown in FIG. 3.

FIG. 4 is a perspective view of the embodiment of a free base motor device of FIG. 3 in a closed position.

FIG. 5 is a perspective view of an embodiment of a free base motor device with four panels in an open position.

FIG. 5A is a perspective view of an embodiment of a free base motor device with eight panels in a closed position.

FIG. 6A is a top perspective view and FIG. 6B is an internal view of an embodiment of a free base motor device including a mechanism for generating a displacement offset.

FIG. 7 depicts an embodiment of a hand interface incorporating a free base motor device.

FIG. 7A depicts detail of the coupling between arms and a panel in the embodiment of FIG. 7.

FIG. 8 depicts an embodiment of a hand interface assembly incorporating a free base motor device.

FIG. 8A depicts another embodiment of a hand interface assembly.

FIG. 9 illustrates an embodiment of a hand-shoulder-elbow interface.

FIG. 10 illustrates an embodiment of a hand-wrist attachment.

FIG. 11 illustrates a whole-arm (hand-wrist-shoulder-elbow) interface.

FIGS. 11A-B show alternative orientations of whole-arm interfaces with respect to a subject.

FIGS. 12A-E depict an embodiment of a controllable advancement device in various stages of advancement.

### DETAILED DESCRIPTION

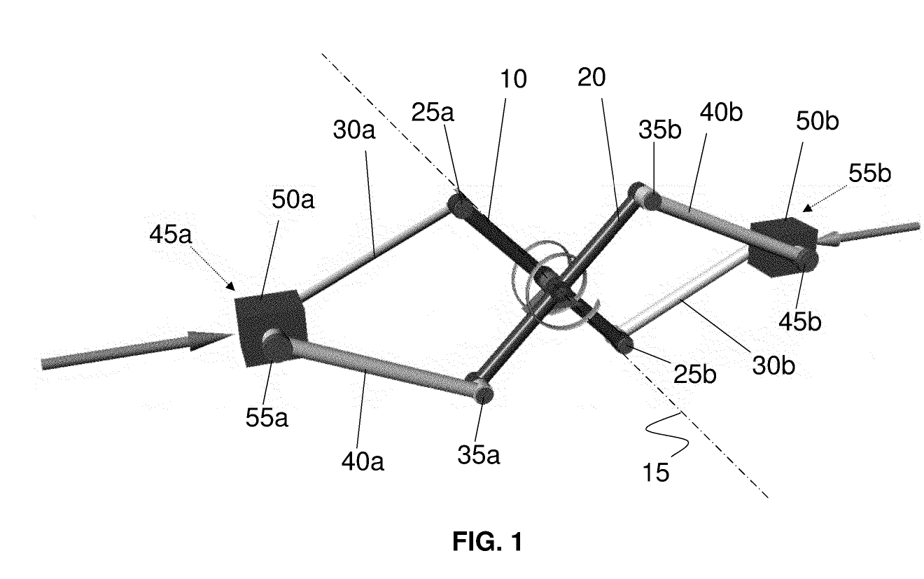

FIG. 1 depicts the kinematic structure that underlies a simple embodiment of an apparatus for converting rotational motion into radial motion. The mechanism includes a first rotor 10 and a second rotor 20 coaxially coupled to one another and rotatable with respect to one another about axis 15. Two first arms 30a, 30b are coupled at their proximal ends to the first rotor by pivot joints 25a, 25b, and two second arms 40a, 40b are coupled at their proximal ends to the second rotor by pivot joints 35a, 35b. Arms 30a and 40a form a first arm assembly, and arms 30b and 40b form a second arm assembly. The first and second arms of the first assembly are coupled at their distal ends to piece 50a by pivot joints 45a (not visible), 55a (shown). The first and second arms of the second arm assembly are similarly coupled to piece 50b by pivot joints 45b (shown), 55b.

When rotors 10, 20 rotate in opposite directions, the arms so pivot as to push pieces 50a, 50b in or out. If the arms of a given assembly have the same length and their proximal ends (coupled at joints 25a, 35a) are positioned at equal distances from the rotors' axis of rotation, then the piece 50 will move radially, i.e., it will move toward or away from the rotors' axis and rotate about that axis.

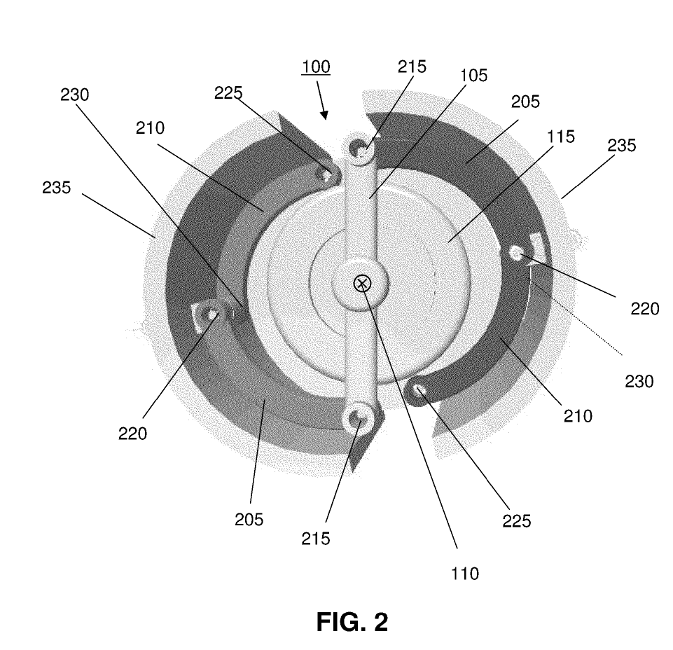

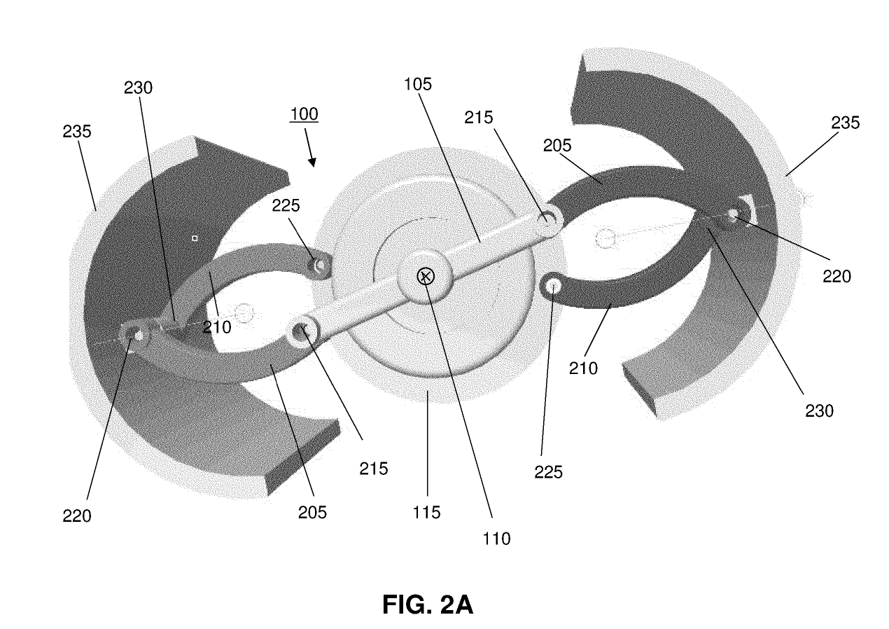

FIG. 2 illustrates a free base motor device 100 for converting rotational motion into radial motion that embodies the kinetic structure of FIG. 1. As illustrated, the free base motor device 100 actuates motion with at least one degree of freedom (DOF). The free base motor device 100 includes a first rotor 105 that is rotatable about an axis 110 and a second rotor 115 that is coaxially disposed in relation to the first rotor 105. A motion generator (not shown) is coupled to the first rotor 105 and the second rotor 115 and causes the two rotors 105, 115 to counter-rotate about the axis 110 with respect to one another. For example, if the first rotor 105 rotates in a clockwise direction, the second rotor 115 rotates in a counter-clockwise direction. In one embodiment, the motion generator includes an electromagnet, but a wide variety of motion generators may be used, such as a field magnet, a hydraulic system, a cable drive, and/or a pneumatic system. The motion generator may be configured to allow the rotors to transition reversibly between various positions, such as open or closed positions. The motion generator may include or be replaced entirely with a biaser, such as a spring, which maintains a degree of torsional torque between the rotors and requires the exertion of an external force to rotate the rotors in the reverse direction.

The motion generator can be disposed in a variety of positions relative to the rotors. For example, if the rotors are annular or toroidal, the motion generator may be located in space inside the rotors. The motion generator can also be disposed at a position distant from the rotors and connected to the rotors by one or more transmissive elements. For example, the motion generator can be connected to the rotor arm assemblies by a cable drive.

Also included in the illustrated embodiment of FIG. 2 are panels 235 (kinematically equivalent to pieces 50a, 50b in FIG. 1). Counter-rotation of rotors 105, 115 enables radial motion of the panels 235. The depicted apparatus includes two arm assemblies and a panel attached to each arm assembly.

In the apparatus depicted in FIG. 2, each arm assembly includes a first arm 205 coupled at its proximal end to the first rotor 105 by a first proximal pivot joint 215, and a second arm 210 coupled at its proximal end to the second rotor 115 by a second proximal pivot joint 225. The distal ends of the first and second arms are spatially fixed with respect to one another. In the depicted embodiment, they are each pivotably coupled to panel 235 by first 220 and second 230 distal pivot joints. In some embodiments, the distal ends of the first and second arms may be pivotably coupled to one another or to an element that connects them, such as a pin. In the depicted embodiment, the pivot joints permit pivoting movement in respective planes with one DOF each. The pivotability of joints 215, 220, 225, 230 allows the distal ends of arms 205, 210 to move outwardly in the radial direction, rather than follow the rotational movement of the rotors 105, 115.

In the embodiment of FIG. 2, the first 205 and second 210 arms of the arm assembly have the same length. Their proximal ends are coupled to the respective rotors at equal radial distances from motor axis 110. Consequently, the counter-rotation of rotors 105, 115 exerts equal but opposite torques on the respective arms. Because the distal ends of the arms are directly or indirectly coupled to one another, the arms constrain one another to move their distal ends radially. That is, the arms so pivot at pivot joints 215, 220, 225, and 230 at to cause the arm distal ends to move together in to or out from the motor axis 110 without rotating around the axis. If some non-radial motion of the distal ends is desired (such as tilting or rotation about the rotors' axis), however, the arms can be given different lengths or can be coupled at different radial distances from the motor axis. This will result in twisting of the distal ends or of a panel coupled to one or both of them.

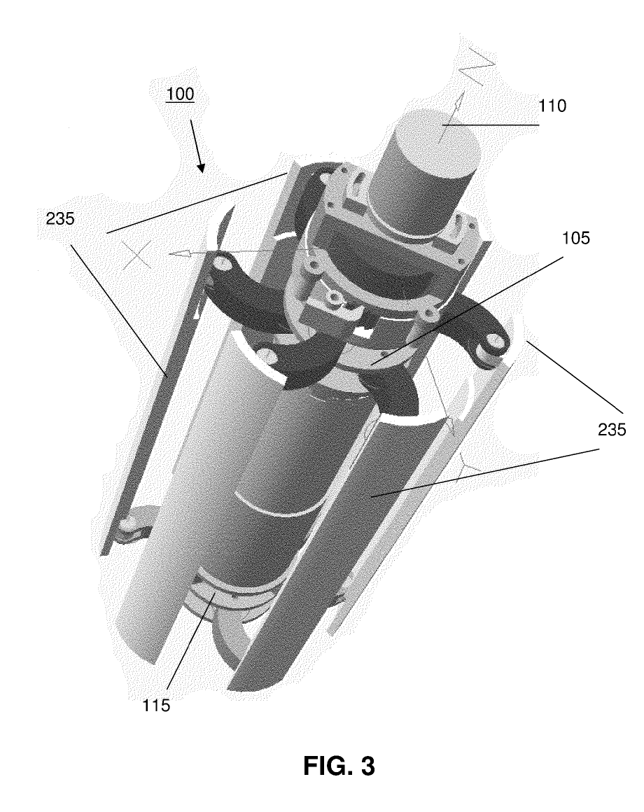

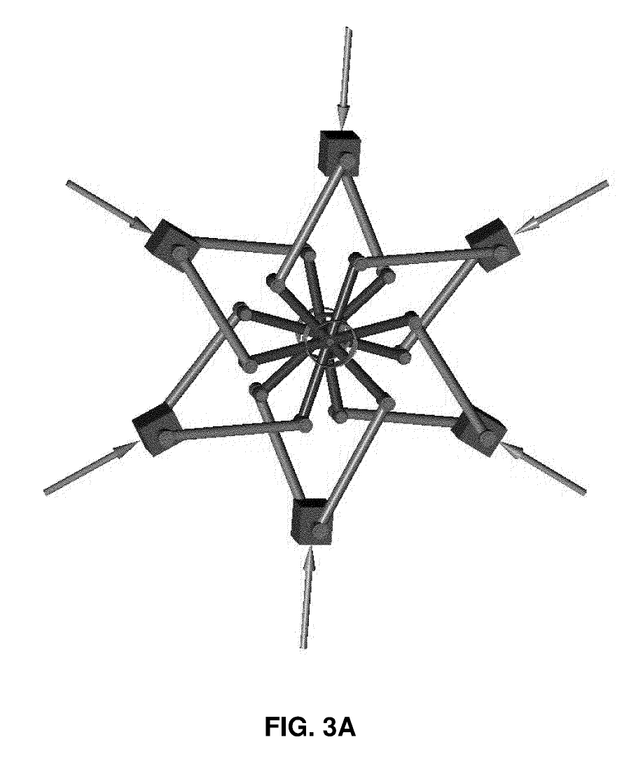

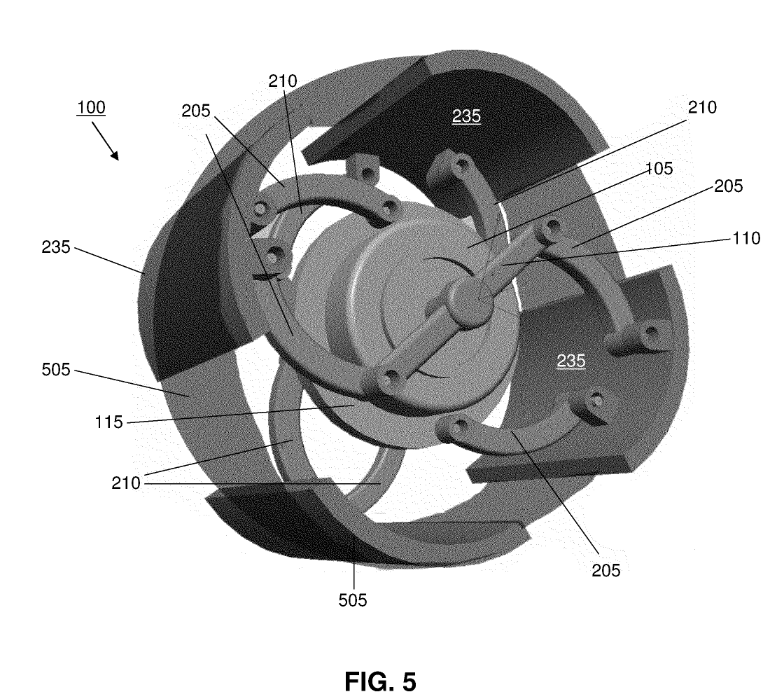

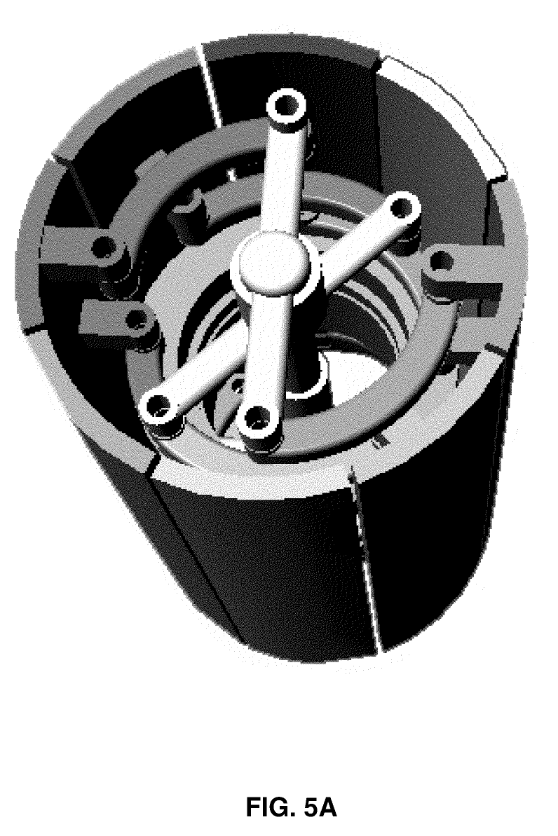

As shown in FIG. 2, the distal joints 220, 230 are pivotably attached to a panel 235 and are spatially fixed with respect to one another. FIG. 2 illustrates an embodiment in which the free base motor device 100 includes two panels 235. As a result, the device opens in two different radial directions. The panels are positioned on opposite sides of the depicted device, so they open in opposite radial directions; in other embodiments, the panels need not be positioned opposite one another. Other embodiments may have just one arm assembly or as many as desired, such as three, four, five, six, seven, eight or more arm assemblies. FIG. 3, for example, shows a device with six arm assemblies, while FIG. 5 shows a device with four arm assemblies, and FIG. 5A shows a device with eight arm assemblies. In these depicted embodiments, the arm assemblies (and panels) are symmetrically disposed around the device. One advantage of symmetrical distribution is that the opening and closing of the panels does not change the axis of rotation of the device (if all the arms have the same mass as one another and the panels have the same mass as one another). For example, if a device is used on a free floating body (such as a space satellite) to open and close panels on the body, it may be preferred that such opening and closing not affect the axis of rotation of the satellite. Furthermore, in some free-floating situations, the opening and closing might be used to control the angular velocity of the device.

The “throw” of a device (i.e., the change in size between the furthest contraction to the furthest expansion) depends on several factors, including the arm lengths, overall size of the device, mechanical advantage, torque and desired contour. The throw desired depends on the intended use of the device. For example, a device being used to deploy panels on a space satellite might have a throw of 1-5 meters, a device being used to train or exercise a human subject's hand might have a throw of a few centimeters, a device being used in a subject's intestine might have a throw of a few millimeters, and a device being used in a subject's blood vessel might have a throw of a few tenths of a millimeter. Larger and smaller throws than these are contemplated.

FIG. 3 depicts an embodiment of a device having six arm assemblies. In FIG. 3, the free base motor device 100 includes six direction mechanisms, which consequently requires six panels 235 and twelve arms. Still, some embodiments may lack panels 235; instead the distal joints 220, 230 may be attached to one another. FIG. 3A depicts the kinematic structure underlying the six-panel embodiment shown in FIG. 3. This structure is analogous to the structure shown in FIG. 1 but shows the interaction of six arm assemblies and twelve arms.

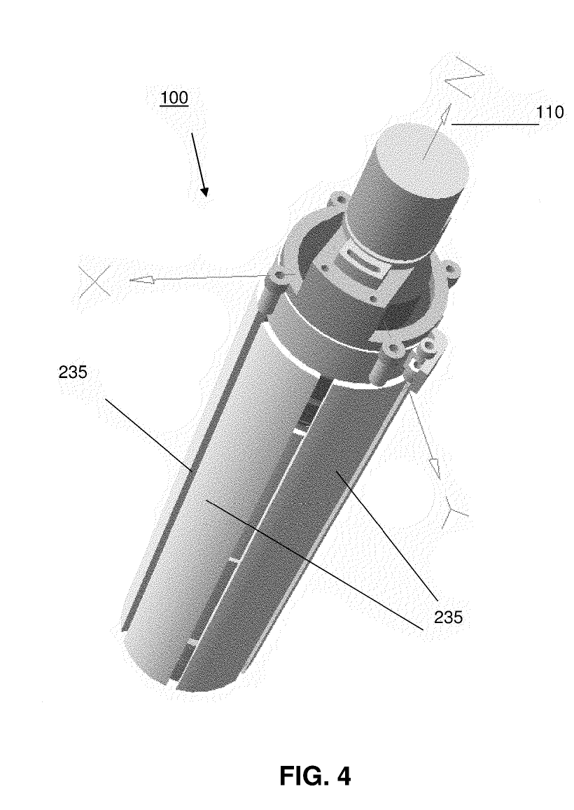

FIG. 3 shows the device in an open position, which results from the rotational movement of the first rotor 105 and the counter-rotational movement of the second rotor 115; together, these rotations cause the six panels 235 to move radially away from the axis 110 into an open position. In contrast, FIG. 4 shows the device in a closed position, which results from rotation of the two rotors in directions opposite to those that result in expansion.

FIG. 5 depicts a device in an open position and having four arm assemblies attached to four panels. As with the other depicted embodiments, panels 235 are configured to form a rounded contour. Such a contour may be appropriate for situations in which the device is positioned in a rounded space. Such spaces include, as examples, tubular conduits such as pipes and blood vessels or a subject's hand grip. In the case of a hand grip, a rounded contour may provide greater comfort than a contour with flat edges. If the contour is polygonal (such as in FIGS. 3-4), the polygon's vertices may be rounded for comfort.

The lengths and/or positioning of the arms in the arm assemblies supporting the panels that define the contour may be so sized to cause the apparatus to maintain the approximate shape of the contour during expansion or to cause the contour shape to change during expansion. For example, if a device has an elliptical contour that is to be maintained during expansion, the arms of an arm assembly supporting a panel that opens along the ellipse's major axis may be proportionately longer than the arms of an arm assembly supporting a panel that opens along the ellipse's minor axis. The arms' positioning can be varied to control how the respective panel will move during expansion and contraction. For example, the proximal ends of arms coupled to one panel may be positioned apart from one another on a rotor at a distance different from that of another set of arms coupled to another panel, so that a given amount of counter-rotation results in different amounts of radial motion for the two panels.

While not required, some embodiments may include a shell 505 made of rubber or other pliable material. The shell 505 covers all or part of the outer surface of the panels and may also cover the space between the panels when the device is open or partially open. The shell may increase the surface area and/or friction between the hand and the panel 235, and thereby enhances a subject's ability to grip the hand interface 100. The shell 505 also may provide added comfort to the subject by increasing the cushioning on the panel 235. Moreover, the shell 505 may reduce the build up of perspiration in the hand. As a result, this enhances the patient's safety and comfort, as well as his or her ability to grasp the hand interface 100. By covering space between panels, the shell can also prevent entrapment of debris or other objects between the panels as they close (for example, pinching a fold of a subject's skin).

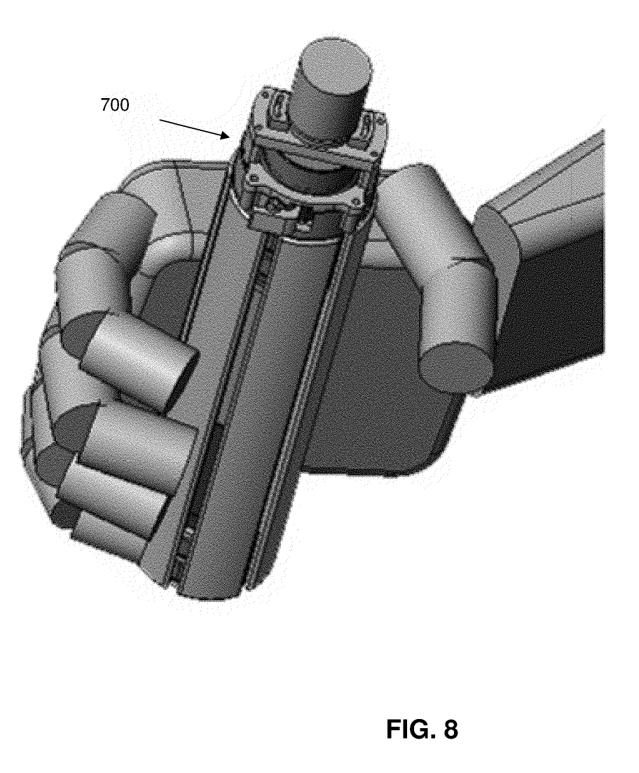

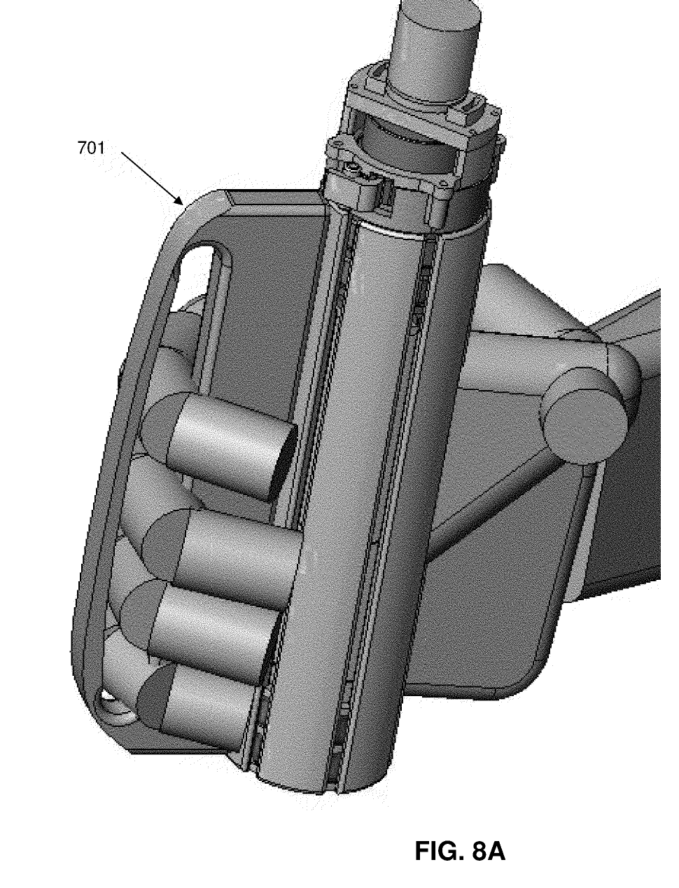

Some embodiments may also include a strap or other restraint, such as strap 701 shown in FIG. 8A, attached to the hand interface and into which a user's fingers are placed. The strap may include, for example, a system of hook-and-loop fasteners, such as VELCRO brand fasteners, to permit snug fitting of the user's fingers. When the user's hand is so restrained, the closing of the hand interface pulls the strap, and consequently the user's fingers, inward. In this manner, the hand interface can recapitulate both the opening and the closing motions of the hand during a grasping movement.

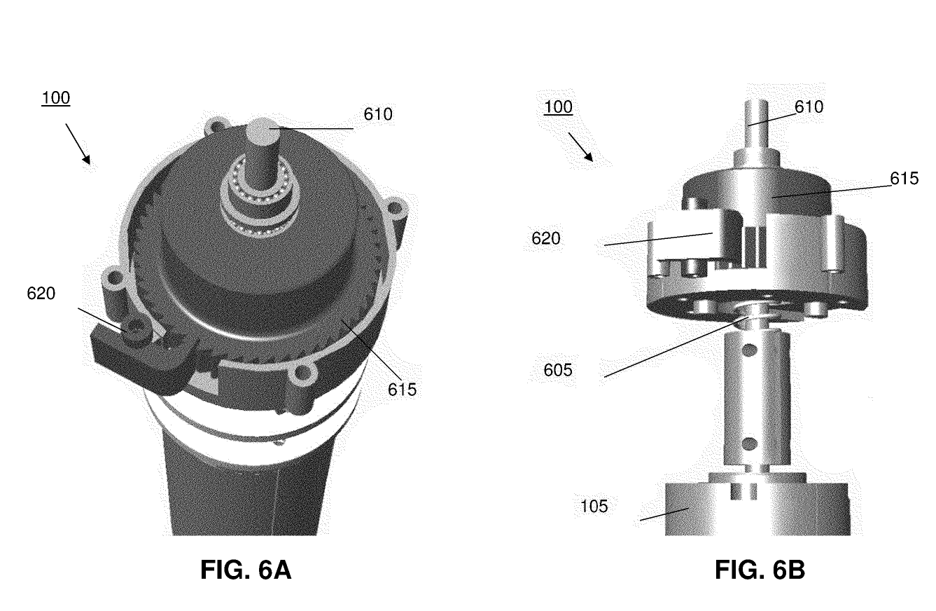

As illustrated in FIGS. 6A-B, the free base motor device also may include a mechanism for creating torque and displacement offset, by which the total torque delivered by the device upon the structure surrounding the device, if any, is passively increased. The offset mechanism may include, for example, torsion spring 605 which adds a bias torque source to the one being provided by the motion generator. In the embodiment shown in FIG. 6A and FIG. 6B, the torsion spring 605 is rigidly coupled to a shaft 610 and a ratchet 615 located on the device. The ratchet 615 includes, on its outer side surface, a number grooves. By turning the ratchet 615, the shaft 610 is forced to rotate in order to balance the torque delivered by the torsion spring 605. Once the ratchet 615 has been rotated to a desired position, a pawl 620 is inserted into one of its grooves in order to prevent the ratchet 615 from rebounding back to its original position.

One reason to include the offset mechanism is to counter a baseline compressive force exerted on the device by a structure surrounding the device. For example, if the device is incorporated into a hand interface that is being used to exercise and/or rehabilitate the hypertonic grip of a stroke victim, the subject may involuntarily grasp the interface with a compressive force that overwhelms the radial force of the panels or at least requires the motion generator to work at or near capacity just to counter the grip strength. The offset mechanism can provide the device with a parallel torque that compensates for the subject's hypertonia and biases the devices to an open position.

A device may also include a controller, such as a computer or other computational circuit, that can control the positions of the rotors (i.e., move the rotors to transition the device to a fully open, partly open, or closed position), set the torque to be generated by the motor, monitor the rotation state(s) of the rotor(s) positions, and/or monitor external forces exerted on a device. The controller can facilitate executing preselected rotor movement patterns (for example, by sending commands or signals in accordance with a sequence stored in controller or external memory to the motion generator) and/or receiving sensor data from the device.

### EXAMPLES

The examples given here illustrate specific embodiments of hand interfaces in order to show with some particularity how a hand interface can be constructed and used. As one familiar with the biomechanical arts will appreciate, a wide variety of options exist in the choice of actuators, sensors, transmissions, materials, etc. that do not bear directly on the inventive aspects of the present disclosure.

### Example 1

### Hand Interface

As described above, a free base motor device can be incorporated into a hand interface. The hand interface can be used to provide therapy, assess a patient's neurological and/or musculoskeletal status, train a subject to make selected hand movements, develop a subject's hand strength, and/or measure hand movements.

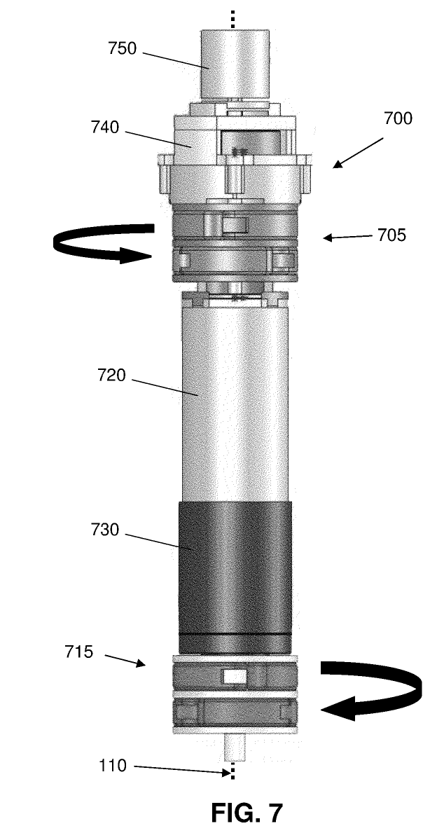

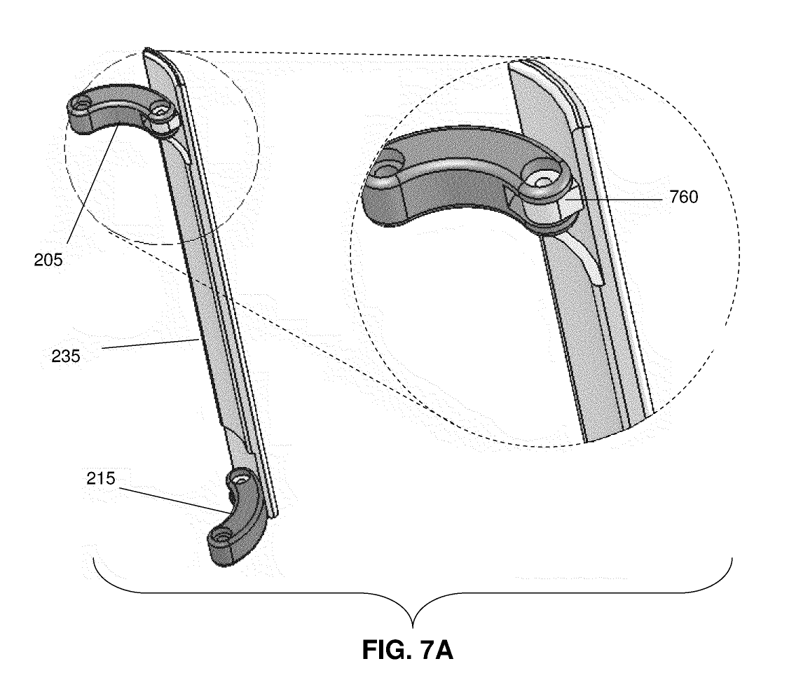

FIG. 7 is a view of portions of an embodiment of a hand interface 700 incorporating free base motor device 100. This embodiment was built with six arm assemblies (total of 12 arms) attached to six panels. The panels are not shown so that interior detail can be appreciated. The depicted device was sized and shaped to fit comfortably in a human subject's manual grip. The first arms of the six arm assemblies are grouped in a first cage 705 which is coupled to the first rotor (not shown), and the second arms are grouped in a second cage 715 which is coupled to the second rotor (not shown). Motor 720 (in this case, a 60 Watt DC brushless motor) provides motion generation, and gearhead 730 can provide a desired mechanical advantage and speed reduction coupling between the motor and the rotors (in this case, a 14:1 reduction, resulting in 910 mNm maximum torque, so that the maximum continuous force exerted on one panel by the motor was approximately 63 N). The interface may optionally include a ratchet and pawl system 740 as previously described, and an encoder 750 or other sensor that senses the rotational state and/or torque of one or both rotors. The first and second arms of each arm assembly are coupled to the respective panel as shown in FIG. 7A, for example, by bearings 760. FIG. 8 provides a schematic view of a hand interface 700 in the grip of a human subject.

In this particular embodiment, the rotors can rotate through 180 degrees with respect to one another, resulting in an open diameter of about 80 millimeters and a closed diameter of about 40 millimeters.

The device may be covered by a rubber cylinder (not shown) in order to conform to the grip shape. As the panels expand, they stretch the rubber cylinder and open the subject's hand.

The length of the panels may be selected to fit the space in which the device is to be used. For example, the panels should be at least about as long as the span of a user's hand if the device is being used to train or exercise all of the hand's fingers.

FIG. 8A schematically depicts a hand interface to which is attached a strap 701; when a user's fingers are received in the strap, the closing of the hand interface exerts a hand-closing force on the user; this allows the hand interface to help the user recapitulate a hand-closing motion.

The hand interface may be connected to a controller as described previously. The controller can be used to provide assistance or resistance to a subject's motion. For example, the controller can cause the device to resist a subject's attempt to close the hand by instructing the motor to generate a torque that will tend to open the device. The controller can cause the device to assist a subject's attempt to open the hand in the same manner. The controller can record the time history of position, velocity, command torques, and current information (motor torques) as games or other training sessions progress.

The hand interface can use impedance control to guide a subject gently through desired movements. If a patient is incapable of movement, the controller can produce a high impedance (high stiffness) between the desired position and the patient position to move the patient through a given motion. When the user begins to recover, this impedance can gradually be lowered to allow the patient to create his or her own movements.

Hand interfaces also can be made mechanically backdrivable. That is, when an attachment is used in a passive mode (i.e. no input power from the actuators), the impedance due to the mechanical hardware (the effective friction and inertia that the user feels when moving) is small enough that the user can easily push the robot around. Using force or torque feedback, the mechanical impedance can be further reduced.

### Example 2

### Hand-Shoulder-Elbow Interface

The hand interface may be combined with a shoulder/elbow motion device to form a hand-shoulder-elbow interface. Such a device may be used to provide therapy, training, and/or measurement of hand, shoulder, and elbow movements. Such combined therapy may have significant advantages over therapy devices for only one joint, because a combined therapy device will be more effective in recapitulating the complex and coordinated upper extremity movements of normal activity.

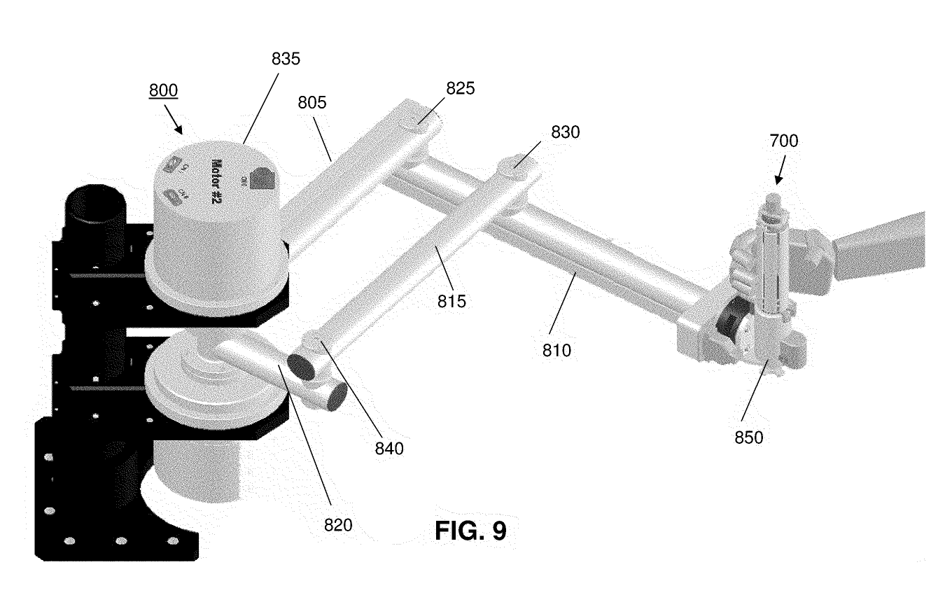

FIG. 9 shows one embodiment of a hand-shoulder-elbow attachment. The hand of a subject may be positioned as to grasp the hand interface 700 as described above. The hand interface 700 itself is coupled to a shoulder/elbow motion device 800. Should/elbow motion devices are described extensively in U.S. Pat. No. 5,466,213 to Hogan, et al., entitled “Interactive Robotic Therapist,” the contents of which are hereby incorporated herein by reference. The shoulder/elbow motion device may include arm member 805, forearm member 810, third member 815, and fourth member 820. The arm member may be coupled at its distal end to the proximal end of the forearm member by an elbow joint 825. The arm member 805 and the forearm member 810 may be rotatable with respect to one another about the elbow joint 825. The third member 815 may be coupled at its distal end to a position along the midshaft of the forearm member by an elbow actuation joint 830. The third member and the forearm member may be rotatable with respect to one another about the elbow actuation joint 830. The fourth member may be coupled at its proximal end to the proximal end of the arm member by a shoulder joint 835. The fourth member and the arm member may be rotatable with respect to one another about the shoulder joint. The fourth member may also be coupled at its distal end to the proximal end of the third member by a fourth joint 840, and the third member and the fourth member may be rotatable with respect to one another about the fourth joint. The four members may be oriented in a plane and be moveable in that plane. In some embodiments, the four members are rotatable in only that plane.

The shoulder/elbow motion device may also include a shoulder motor coupled to one of the joints and controlling motion of the shoulder joint. The shoulder/elbow motion device may further include an elbow motor coupled to one of the joints and controlling motion of the elbow actuation joint. The motors may be located at shoulder joint 835. Locating the motors far from the end point can reduce inertia and friction of the device. In some embodiments, the motors may be aligned along a vertical axis so that the effects of their weight and that of the mechanism is eliminated.

Hand interface 700 may be attached to the distal free end of forearm member 810 by a mount 850. The mount may provide one degree of freedom for rotation about the mount axis.

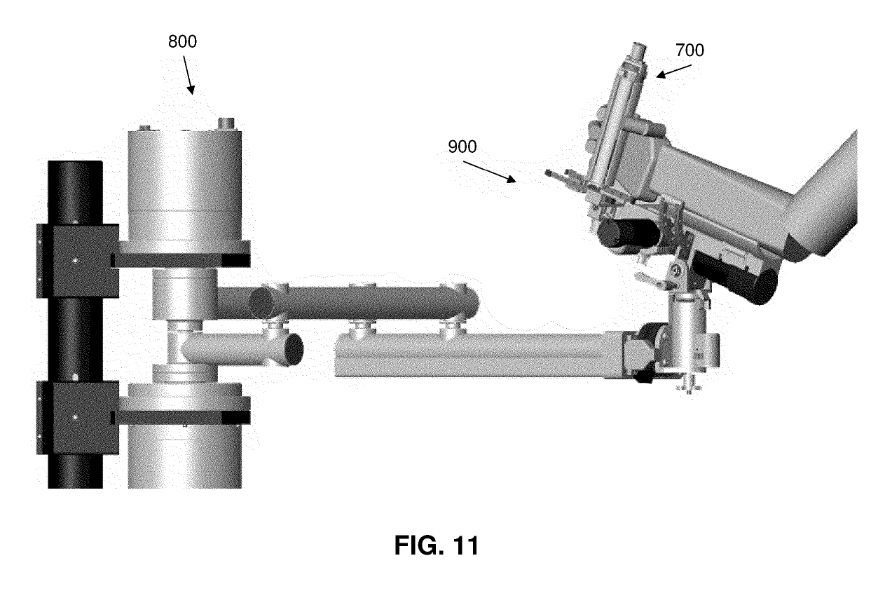

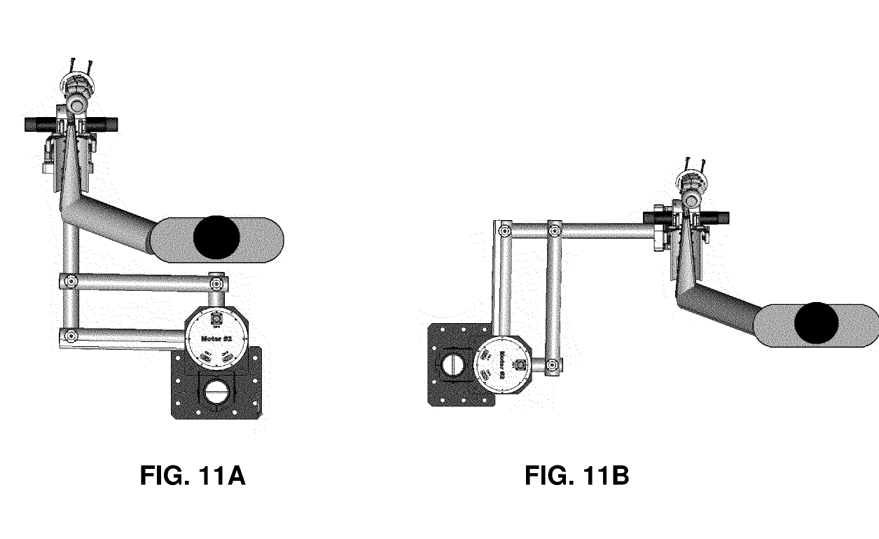

The embodiment of FIG. 9 positions the shoulder/elbow motion device in front of the subject, but other positions are also possible, such as to the side or behind the subject. FIGS. 11A-B show such positions for a whole-arm attachment.

### Example 3

### Hand-Wrist Attachment

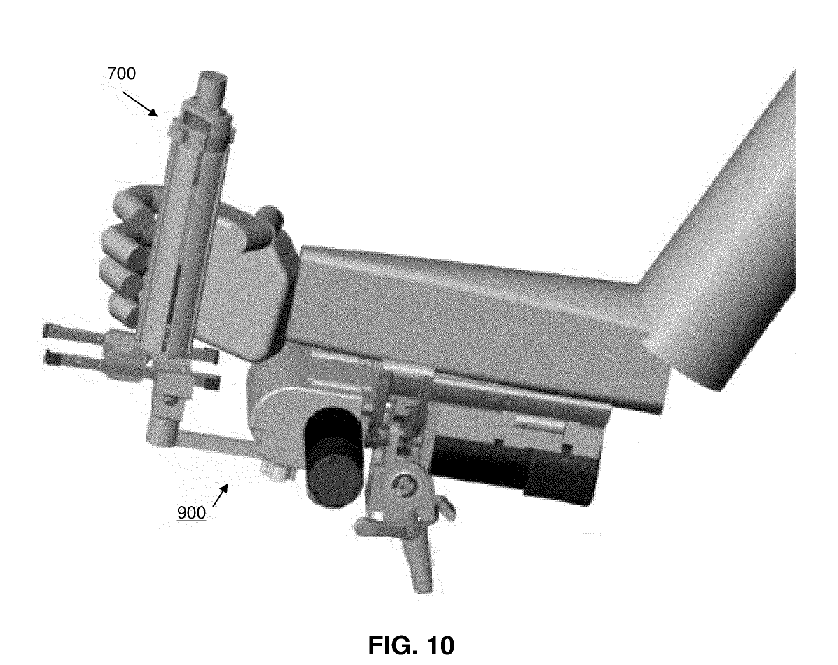

Similarly, the hand interface may be combined with a wrist motion device to form a hand-wrist attachment. FIG. 10 illustrates one embodiment of a hand-wrist attachment. The hand of a subject may be positioned as to grasp the hand interface 700 as described above. The hand interface 700 is coupled to a wrist motion device 900. Wrist attachments are described extensively in U.S. application Ser. No. 10/976,083 of Krebs, et al., entitled “Wrist and Upper Extremity Motion,” the contents of which are hereby incorporated herein by reference. The hand interface 700 can replace the handle described in that application.

### Example 4

### Whole-Arm Attachment

In yet another alternative, the hand interface may be combined with both the shoulder/elbow motion device and the wrist motion device to form a whole arm attachment. This combined system can coordinated therapy for the hand, wrist, elbow and shoulder. Such a system may be particularly useful for helping a subject learn complex motions of the upper extremity, evenly develop strength in muscle groups, and measure a wide variety of parameters that describe arm movements.

FIG. 11 depicts an exemplary embodiment of a whole-arm attachment, including hand interface 700 coupled to wrist attachment 900, which in turn is mounted on the distal free end of the shoulder-elbow motion device 800. The subject is positioned so that the forearm rests on the wrist attachment, as described in U.S. application Ser. No. 10/976,083. The shoulder-elbow motion device may be positioned in front of (FIG. 11), in back of (FIG. 11A), or to the side of (FIG. 11B) the subject. A monitor may be provided in front of the patient to convey the orientation of the robot and the desired motions.

A computer can be programmed to administer “games” to exercise or train various wrist and upper extremity motions. The computer program may instruct the hand interface to exert assistive or resistive torques to help or to challenge the subject, as appropriate.

Hand-wrist, hand-shoulder-elbow, and whole arm attachments can be used in a wide variety of applications. Two broad categories of uses are actuating and sensing. In actuating modes, the devices impart torques or forces on a user's hand, wrist or upper extremity. These torques can be assistive (that is, helping a user move the hand, wrist or upper extremity in the way the user wishes or is directed), or they can be resistive (that is, making it harder for a user to move the hand, wrist or upper extremity in the way the user wishes or is directed) or they can perturb the limb in a precisely controllable manner. Actuating modes are particularly well-suited for rehabilitation and training applications, in which a user is attempting to develop accuracy and/or strength in a particular hand, wrist, shoulder-and-elbow or whole-arm motion. In sensing modes, the devices measure position and/or velocity of the device (and thus of the user), and/or torques exerted by the user on the device. Sensing modes are well-suited for diagnostic, investigational, and training applications, in which a user's performance is being assessed or hand movements are being compared to other measurements. In many circumstances, a device may operate in both actuating and sensing modes. For example, in a training application, the device controller may direct a user to make a certain motion, monitor the user's ability to make the motion, and cause the device to provide assistive or resistive or perturbation forces in response to the user's voluntary motions.

### Example 5

### Neurorehabilitation

Presently the neurorehabilitation process is a very labor intensive process. A single patient requires several hours with an occupational or physical therapist on a daily basis to regain motor skill. The estimated annual direct cost for the care of stroke victims is $30 billion. The various devices disclosed herein may be used to help aid the recovery of patients with neurological disorders, muscular disorders, neuromuscular disorders, arthritis (or other debilitating diseases) or with hand impairment following surgery. In addition to helping patients recover, the devices can be used to collect data on patient movement in a given therapeutic session and over several sessions. This data can help therapists quantify patient improvement and/or identify patient problem areas.

### Example 6

### Angioplasty

Presently, angioplasty requires the insertion of a balloon at the end of the catheter. The balloon is inflated at the blockage point to clear the arteries. Thus, the present device can replace the balloon and be threaded via a catheter into an artery in a leg, an arm or a wrist of a subject. Once the catheter is threaded through the artery and into the subject's heart, the motion generator may be actuated to cause the device to expand into an open position. This motion recapitulates the compressive effect of the balloon and can clear the blockage in the coronary arteries.

In order to facilitate the making of a small-sized device, the motion generator may be located at a distance from the rotor-arm system. For example, the motion generator may be connected to the rotor-arm system by a cable drive, so that the motion generator is outside the subject's body, and the counter-rotation torques are transmitted to the rotors by coaxial cables extending through the catheter.

### Example 7

### Endoscopy

During an upper endoscopic procedure, a long, flexible tube is inserted via the mouth of the patient. The flexible tube is threaded to the patient's esophagus, stomach, small intestine, or biliary tree, where the physician may examine the area more closely. The free base mechanism device may be attached to one end of the flexible tube, and its panels expanded against the walls of the esophagus, the stomach or the small intestine. The device provides the physician with a larger opening to perform a minimum invasive surgery to open and clean an obstruction.

During a lower endoscopic procedure, a long, flexible tube is inserted via the rectum of the patient. The flexible tube is threaded to the patient's colon where the physician may examine the area more closely. The present device may be attached to one end of the flexible tube and its panels expanded against the walls of the colon. Similarly, the device provides the physician with a larger opening to perform the procedure, e.g. colonoscopy.

The motion generator may be remotely located by using a cable drive, as described previously.

Endoscopic devices may include a camera, fiber optics, or other imaging systems for visualizing the gastrointestinal tract. Devices for visualization of other body cavities or lumens, such as by angiography or cystoscopy may be similarly made.

### Example 8

### Brain research

The various devices disclosed herein may be used to map hand activity to brain activity. The robot's computer accurately records the position, velocity and acceleration of the hand. Using a technology capable of monitoring or imaging the brain, such as EEG (electro-encephalography), PET (positron emission tomography), or fMRI, or NIRS (Near Infrared Spectroscopy), the relationships between hand motions and brain activity can be mapped.

### Example 9

### Telerobotics and device control

The various devices could be used to describe the orientation of a robot end-effector and could also be used to transmit torques sensed by the robot back to the operator. They could be used to control small manipulators for tele-surgery robots or in robots for dangerous environments (such as space tele-robots), or to control other devices, such as airplanes, automobiles, underwater vehicles, and the like. In some embodiments, the device may be a haptic interface.

### Example 10

### Fine motion control

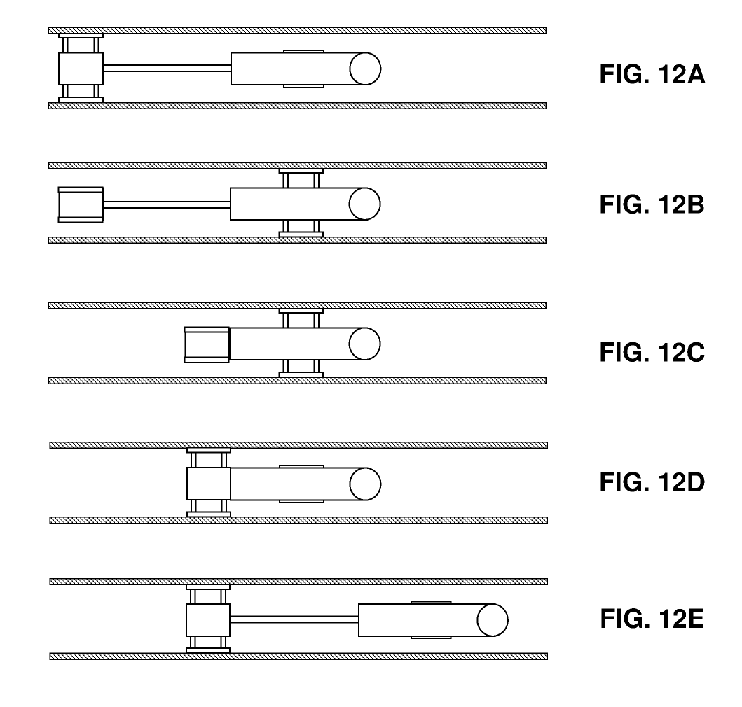

Free base motor devices can be used to provide fine control of the motion of an object, as shown in FIGS. 12A-E. Two free base motor devices can be mounted on an object (such as a camera assembly) spaced apart from one another. By alternating opening and closing of the free base motor devices, the object can be made to creep or “inch” along a conduit (such as a pipe, gastrointestinal tract, blood vessel, or other hollow body organ). In the depicted schematic embodiment, a rear free base motor is mounted on a retractable shaft, and a front free base motor device is mounted on a more forward position of the object. To advance the object, the rear device is closed, the shaft is drawn into the object, the rear device is opened, the front device is closed, and the shaft is extended. The object can be moved backward by reversing the process. Such motion control can reduce or eliminate the shear force to which the conduit being “crawled” is subjected.

### Example 11

### Variable Transmission

Free base motor devices can be used as a variable transmission or propulsion by changing the diameter of for example the vehicle wheels, a crank, a continuously variable transmission system (CVT), or the sprockets driving a belt or chain.

### Example 12

### Propulsion System

Free base motor devices can be used in the propulsion system by changing the diameter of, for example, the radius of rotation of a Voith-Schneider propeller.

What is claimed is:

1. An apparatus for converting rotational motion into radial motion, the apparatus comprising:
a motor including:
a) a first rotor rotatable about an axis;
b) a second rotor coaxially disposed in relation to the first rotor, the second rotor rotatable about the same axis as the first rotor; and
c) a motion generator coupled to the first rotor and the second rotor, the motion generator causing the two rotors to counter-rotate about the axis with respect to one another; and
an arm assembly including:
a) a first arm having a first proximal end and a first distal end, the first proximal end being pivotably attached to the first rotor; and
b) a second arm having a second proximal end and a second distal end, the second proximal end being pivotably attached to the second rotor; and
optionally, a panel pivotably attached to both the first distal end and the second distal end;
wherein the first distal end and the second distal end are spatially fixed with respect to one another but rotatable with respect to one another, so that counter-rotation of the rotors causes both distal ends and the panel, if present, to move radially away from the axis.

2. The apparatus of claim 1, wherein the first rotor and the second rotor are reversibly transitionable between a first position in which the arm assembly and the panel, if present, are in an open orientation and a second position in which the arm assembly and the panel, if present, are in a closed orientation.

3. The apparatus of claim 1, wherein the apparatus further comprises a plurality of panels configured to form a contour.

4. The apparatus of claim 3, wherein the contour is rounded.

5. The apparatus of claim 3, further comprising a shell disposed about the plurality of panels, the shell comprising a pliable material.

6. The apparatus of claim 3, wherein the contour is adapted to a primate hand.

7. The apparatus of claim 6, wherein the primate hand is a human hand.

8. The apparatus of claim 1, wherein the motion generator comprises at least one of an electrical motor, a field magnet, a cable drive, a hydraulic device, and a pneumatic device.

9. The apparatus of claim 1, further comprising at least one sensor.

10. The apparatus of claim 9, wherein the sensor is a motion sensor.

11. The apparatus of claim 10, wherein the motion sensor comprises an optical encoder.

12. The apparatus of claim 10, further comprising a display.

13. The apparatus of claim 12, wherein the display shows an interactive game responsive to a signal produced by the sensor.

14. The apparatus of claim 10, further comprising at least one torque and/or force sensor.

15. The apparatus of claim 9, wherein the motion sensor produces signals indicative of a motor skill performance of a person.

16. The apparatus of claim 1, further comprising a controller coupled to the motion generator.

17. The apparatus of claim 16, wherein the controller comprises a computer.

18. The apparatus of claim 16, wherein the controller comprises a memory.

19. The apparatus of claim 18, wherein the memory stores a sequence of commands or signals to control actuation of the motion generator.

20. The apparatus of claim 1, wherein the rotors are held in at least one position relative to one another.

21. The apparatus of claim 20, wherein the rotors are held in the at least one position relative to one another by a ratchet assembly.

22. The apparatus of claim 21, wherein the ratchet assembly comprises:
a shaft coupled to the motor;
a torsion spring connected to the shaft;
a grooved ratchet coupled to the torsion spring, wherein the grooved ratchet is rotatable to a position; and
a sliding bolt coupled to the first rotor, wherein the sliding bolt fits into a groove of the grooved ratchet, thereby holding the grooved ratchet in the position.

23. The apparatus of claim 1, wherein the apparatus comprises:
at least two panels configured to form a contour, the contour being so sized and shaped as to be able to receive a hand around the contour, and the apparatus further comprises:
at least one sensor associated with the motion generator;
at least one torque and/or force sensor being associated with the motion generator; and
a controller associated with the motion generator;
wherein the motion generator comprises at least one of an electrical motor, a field magnet, a cable-driven device, a hydraulic device, and a pneumatic device.

24. The apparatus of claim 1, further comprising at least one additional arm assembly.

25. The apparatus of claim 24, wherein the arm assemblies are symmetrically distributed about the apparatus.

26. The apparatus of claim 1, wherein the first arm and second arm have equal lengths between the respective proximal and distal ends.

27. The apparatus of claim 1, wherein the first proximal end and the second proximal end are positioned at the same distance from the axis.

28. The apparatus of claim 27, wherein the first arm and second arm have equal lengths between the respective proximal and distal ends.

29. A hand interface, comprising the apparatus of claim 1, sized and shaped to fit within the grip of a human hand.

30. The hand interface of claim 29, further comprising:
a plurality of panels;
a shell of pliable material disposed about the plurality of panels;
a controller coupled to the motion generator; and
at least one sensor.

31. An upper extremity interface, comprising:
the hand interface of claim 29 pivotably mounted to a shoulder-elbow motion device, the shoulder-elbow motion device comprising:
a) a shoulder support adapted to receive a shoulder of a subject;
b) a member assembly having at least one degree of freedom and a free distal end; and
c) a motor coupled to the member, thereby driving the member.

32. An upper extremity interface, comprising:
the hand interface of claim 29 pivotably mounted to a wrist motion device, the wrist motion device comprising:
a) a forearm support adapted to receive a forearm of a subject, wherein the forearm support defines a long axis; and
b) a transmission system providing rotation with three degrees of freedom.

33. The interface of claim 29, wherein the wrist motion device is pivotably mounted to a shoulder-elbow motion device, the shoulder-elbow motion device comprising:
a shoulder support adapted to receive a shoulder of a subject;
a member assembly having at least one degree of freedom and a free end; and
a drive system coupled to the member, thereby driving the member, wherein the drive system comprises at least one motor.

34. An angioplasty device, comprising the apparatus of claim 1 attached to a distal portion of a catheter, the axis of the apparatus being aligned with a longitudinal axis of the catheter.

35. An endoscopy device, comprising a camera and the apparatus of claim 1 attached to a distal portion of a flexible tube, the axis of the apparatus being aligned with a longitudinal axis of the flexible tube.

36. A propulsion system for an article, comprising:
a first apparatus according to claim 1 attached to a first portion of the article; and
a second apparatus according to claim 1 attached to a second portion of the article, the second portion of the article being displaceable relative to the first portion.

37. A method of hand training, comprising:
contacting a subject's hand to the panels of the hand interface of claim 29; and
actuating the motor to provide at least one of assistance, perturbation and resistance to a hand compression motion.

38. An angioplasty method, comprising:
inserting the distal portion of the catheter of the angioplasty device of claim 34 into a blood vessel of a subject;
advancing the distal portion of the catheter to a blockage within the blood vessel; and
causing the arm assembly of the apparatus of the angioplasty device to assume an expanded orientation, thereby compressing the blockage against a wall of the blood vessel.

39. An endoscopy method, comprising:
passing the distal portion of the flexible tube of the endoscopy device of claim 35 through an orifice of a subject's gastrointestinal tract;
advancing the flexible tube to a region of the subject's gastrointestinal tract;
causing the arm assembly of the apparatus of the endoscopy device to assume an expanded orientation; and
visualizing the region of the subject's gastrointestinal tract.

40. A method of moving the article of claim 36 through a conduit, comprising:
introducing the article into the conduit;
expanding the second apparatus;
displacing the first portion of the article away from the second portion;
expanding the first apparatus;
contracting the second apparatus; and
displacing the second portion of the article toward the first portion.
